(19) United States
(12) Patent Application Publication
(10) Pub. No.: US 2011/0305813 A1
(43) Pub. Date: Dec. 15, 2011

(54) Spreadable Butter Formulations

(76) Inventor: Van Miller, Norval (CA)

(21) Appl. No.: 13/159,098

(22) Filed: Jun. 13, 2011

(30) Foreign Application Priority Data
Jun. 11, 2010 (CA) 2707287

(51) Int. Cl. A23C 15/12; A23D 7/00; A23D 7/01; A23C 15/02

(52) U.S. Cl. 426/581; 426/604

(57) ABSTRACT

A spreadable butter product, with a method of production, wherein vegetable oil is combined with already churned butter. The vegetable oil, which is preferably canola oil, contains low levels of a phospholipid such as lecithin, so as to reduce the surface tension of the system, and thereby reduce or eliminate the absorption of the vegetable oil into the crystal structure of the butterfat in the butter. As a result, the crystalline structure of the churned butter is retained. The spreadable butter is spreadable at refrigerator temperatures, and has improved system stability which allows it to remain spreadable for longer periods of time.

### FIELD OF THE INVENTION

The present invention relates to the field of spreadable butter, and in particular, relates to a butter-based product which can be used in the same way as butter, but which is spreadable at refrigerator temperature (e.g. about 4°-8° C.). In particular, the present invention is directed to the production of a spreadable butter product which is produced after butter has been formed by churning of a milk-based product, and preferably by the churning of dairy cream. In the present invention, the already churned butter is combined with low levels of a pre-mixed combination of a vegetable oil or oils, and a phospholipid such as lecithin.

### BACKGROUND OF THE INVENTION

Butter is a dairy product made by churning fresh or fermented cream or milk. It is generally used as a spread and a condiment, as well as in cooking applications, such as baking, sauce making, and pan frying. Butter consists of butterfat, water and milk proteins. While butter is typically made from cows' milk, butter can also be manufactured from the milk of other mammals, including sheep, goats, and the like. Butter can be sold as-is, but commonly, salt, flavorings and/or preservatives are also added.

Butter remains a solid when refrigerated, but softens to a spreadable consistency at room temperature of about 20-25° C., and typically melts to a thin liquid consistency at 32-35° C. (90-95° F.). Unfortunately, in order to reduce problems with rancidity, or bacterial contamination, butter is typically stored at refrigerator temperatures, and at these temperatures, it is not readily spreadable.

While, butter can be left out of the refrigerator (i.e. at room temperature) using devices such as a “butter bell”, this approach is not optimal. In contrast, one of the significant advantages of margarine products, is not only cost, but the fact that the margarine is spreadable at refrigerator temperatures.

Various approaches have been used to provide butter that is spreadable at refrigerator temperatures. For example, “fractionation” of the butter has been used which requires melting of the butter, separation of various components, and then re-combining only specifically chosen components in order to produce a butter which would be spreadable at room temperature. However, this approach requires melting of the butter, applying the various separation techniques, and re-crystallization of the chosen components. Moreover, the remaining components of the butter must be sold or disposed of, in some fashion.

Spreadable butters have also been produced by closely controlling the cattle feed so as to produce milk and cream which is provides a butter which is softer at refrigerator temperatures. This is not practical in most applications, on a larger scale.

Other approaches include “chemical interesterification”, which involves rearranging the fatty acids in butter, or “enzymatic interesterification”, but again, these approaches are not practical on larger scales, or require significant investment.

Another class of spreadable butter can be described as “butter-based spreads.” These are usually produced by adding various edible oils such as vegetable oils (e.g. canola oil, olive oil, peanut oil, and the like), to produce a butter-oil combination, which is spreadable at refrigerator temperatures. However, the level of butter in a butter-based spread is commonly very low.

It should be noted that the edible oil can be added to the milk or cream prior to churning, or it can be added to the butter once the butter has been formed by churning of the dairy cream. However, it has been noted that if the oil is added to a butter product which is already churned, the resulting product will exhibit acceptable initial spreadability, but will develop a rubbery consistency after short storage periods due to the adsorption of the oil into the crystalline butterfat. As such, the spreadability of the product decreases over time.

In a technical sense, butter is a water-in-oil emulsion resulting from an inversion of the cream (which is an oil-in-water emulsion wherein the milk proteins are the emulsifiers). The amount of butterfat in the finished butter product is a key factor of the finished butter component. In order to be sold as “butter” the amount of butterfat must be maintained above specified levels depending on the applicable government regulations. For example, in various states of the United States, products sold as “butter” are required to contain a minimum of 80% butterfat. The balance is usually entrained water remaining in the butterfat mixture.

In practice most U.S. butters contain only slightly more than that, averaging around 81% butterfat with the balance being primarily water, but may also include salt, sugar, herbs, spices, milk proteins, flavourings, gelatins and/or other additives. European butters generally have a higher ratio, which may extend up to 85%.

For spreadable butter, the amount of butterfat required is further reduced. In Canada, various provincial regulations can require the level of butterfat in a spreadable butter to be maintained at various levels. In Ontario, the butterfat content of a spreadable butter must be above 51%, with the balance (based on solids) being added oil. The total solids generally amount to 80% of the weight of the spreadable butter, with the balance being water, salt, or other additives.

The minimum level of butterfat in a spreadable butter can, however, vary from province to province.

To overcome these difficulties, it would be advantageous to provide a butter product which is produced from already churned butter, and which remains spreadable at refrigeration temperatures over longer time periods.

### SUMMARY OF THE INVENTION

Accordingly, it is an objective of the present invention to provide a spreadable butter which is produced from an already churned butter product.

It is a further objective of the present invention to provide a spreadable butter which contains a minimum of at least 51% butterfat by weight, based on solids.

It is a still further objective of the present invention to provide a process for producing a spreadable butter which does not interfere or otherwise affect the butter churning process, and without making any significant changes to the butter churning equipment.

The advantages set out hereinabove, as well as other goals and objectives inherent thereto, are at least partially or fully provided by the spreadable butter, of the present invention, as set out herein below.

Accordingly, in one aspect, the present invention provides a spreadable butter which is spreadable at refrigerator temperatures of about 4 to 8° C. comprising a mixture of between 25 and 90% butterfat, based on weight of solids, between 10 and 75% percent of a vegetable oil, and between 0.2 and 5% of a phospholipid, with the resulting product including up to 25% by weight of water and other additives, and wherein the butterfat is from churned butter, and essentially retains the crystalline structure of churned butter.

The addition of a low level of a phospholipid aids in reducing the surface tension of the system, and thereby aids in maintaining the spreadability of the spreadable butter products prepared in accordance with the present invention.

In a further aspect, the present invention also provides a method for the production of a spreadable butter comprising: i) preparing a pre-mixed oil product by mixing a combination of between 0.2 and 5% by weight of solids of a phospholipid with between 10 and 75% of a vegetable oil, and ii) mixing said pre-mixed oil product with between 25 and 90% already churned butter, in order to produce a spreadable butter as described hereinabove.

### DETAILED DESCRIPTION OF THE INVENTION

In the present application, the term “spreadable” refers to a butter which is spreadable at refrigerator temperatures which are commonly between about 4 and 8° C. The spreadable butter is such that it can be spread on materials such as bread, baked goods, or the like, without significant damage to the surface of the bread, baked goods, or the like. As such, the spreadable butter of the present invention exhibits spreadability at temperatures of between 3 and 12° C., and more preferably, at refrigerator temperatures of between 4 and 8° C., which is similar to normal 100% butter at room temperature (e.g. at 20 to 24° C.).

The term “spreadable” is well known in the butter art, and the skilled artisan will be well aware of the specific nature of a spreadable butter product.

As previously indicated, the initial butter product has preferably been pre-formed; —such as by churning of a dairy product such as milk, but more preferably cream. The source of the dairy product is commonly from cows, but any suitable milk or cream product might be used.

The amount of butterfat in the spreadable butter formulations of the present invention can vary depending on various government regulations, or the like, but is typically between 25 and 90% of the spreadable butter formulation (by weight of solids). More preferably, the level of butterfat is maintained between 40 and 70%, and still more preferably, the level of butterfat is maintained at between 45 and 60% butterfat.

The level of vegetable oil is typically between 10 and 75% of the formulation, based on weight of solids. More preferably, however, the amount of vegetable oil is between 30 and 60%, and still more preferably between 40 and 55%.

Any suitable, edible vegetable oil might be used. These include, for example, olive oil, corn oil, cottonseed oil, palm oil, peanut oil, rapeseed oil (including canola oil), safflower oil, sesame oil, soybean oil, sunflower oil, nut or seed oils such as almond oil, cashew oil, pine nut oil, hazelnut oil and the like, oils from melon and gourd seeds such as pumpkin or watermelon seed oil and the like, or any other suitable and edible oil. Combination of the various oils might also be used.

Most preferably, however, the vegetable oil is canola oil, soybean oil, olive oil or peanut oil, with canola oil being most preferred.

The oil is pre-mixed with a phospholipid which preferably is a glycerophospholipid (or phosphoglycerides), which can be, for example, phosphatidyl inositol, cephalin, lecithin, phosphatidyl serine or cardiolipin, with lecithin being most preferred.

The level of phospholipid, and more specifically lecithin, is preferably between 0.2 and 5% by weight of solids. More preferably, the level of phospholipid, and specifically lecithin, is between 0.4 and 2.5%, and still more preferably, between 0.5 and 1%. At these levels, the phospholipid aids in reducing the surface tension of the oil and butterfat system, and thereby, aids in preventing the absorption of the oil into the butterfat and producing a rubbery consistency. This aids in maintaining spreadability of the spreadable butter product of the present invention.

The pre-mixed oil product comprising vegetable oil and phospholipid (and more specifically and preferably, a mixture of canola oil and lecithin), remains a liquid material which is easily mixed together, and can be easily added to the already churned butter, in the amounts desired, by blending and mixing the pre-mixed oil product using any suitable blending and mixing equipment suitable for materials of the consistency of butter.

Mixing of the pre-mixed oil product with the butter can be done at any suitable temperature which allows mixing, without melting of the butter. Preferably, mixing is conducted at between 10 and 20° C.

The resultant product can be dispensed into tubs for storage and sale, or can be stored in bulk.

A primary advantage of the spreadable butters of the present formulation is that spreadability remains good over longer time periods than prior art mixtures of pre-churned butter and vegetable oil. As indicated above, and without being bound by theory, it is believed that the phospholipid acts as an emulsifier in the mixture to reduce the surface tension of the system, and reduce or prevent the vegetable oil from being incorporated into the crystal structure of the butterfat.

As such, the addition of the phospholipid effects a reduction in surface tension over a system comprising corresponding levels of only vegetable oil and butter. Consequently, the crystalline structure of the butter is essentially maintained since churned butter is used in the process. In particular, the need for re-crystallization of the butter as a result of melting, interesterification or fractionation of the butter, is not required. This is important in maintaining the proper texture and mouth feel of the butter, when consumed. The texture and mouth feel of the butter can be easily lost in melted or fractionated butters. Thus, by using “churned” butter (meaning butter that is used as produced without melting, interesterification or re-fractioning, or the like), the butter essentially retains its original crystalline structure. Accordingly, it is believed that the use of the phospholipid is to control the surface tension of the system, and thereby minimize the impact of the vegetable oil on the crystalline structure of the churned butter. As a result, the spreadable butters of the present invention are spreadable at refrigerator temperatures, avoid extra steps such as interesterification or heating steps for melting and/or refractionation, avoid the rubbery texture sometimes associated with prior art spreadable butters on storage, and maintain the crystalline structure of churned butter, and thus retain the texture and mouth feel of traditional churned butter.

A further advantage of the technique of the present invention is that it can be practised on a large scale, using a pre-formed butter material produced from a manual or automatic churning process. As such, it can be readily and easily added to an existing butter production line, without incurring a significant expense.

It should also be noted that while similar composition are known in the prior art, these typically include much higher levels of phospholipids and vegetable oil, and thus, greatly reduced amounts of butterfat. In the present application, only sufficient vegetable oil is added to effect the desired spreadability, and only sufficient phospholipids are added to effect stability of the system, by reducing surface tension, in order to maintain the spreadability over longer time storage periods.

Preferably, the longer storage time periods for maintaining spreadability are over 3 months, more preferably, over 6 months, and still more preferably, over 12 months (when stored at refrigerator temperatures).

### BRIEF DESCRIPTION OF THE DRAWINGS

Embodiments of this invention will now be described by way of example only in association with the accompanying drawing in which:

FIG. 1 is a schematic representation of a spreadable butter production method according to the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawing in which a presently preferred embodiment of the invention will now be illustrated by way of example only. In the drawing, like reference numerals depict like elements.

It is expressly understood, however, that the drawing is for the purpose of illustration and description only and is not intended as a definition of the limits of the invention.

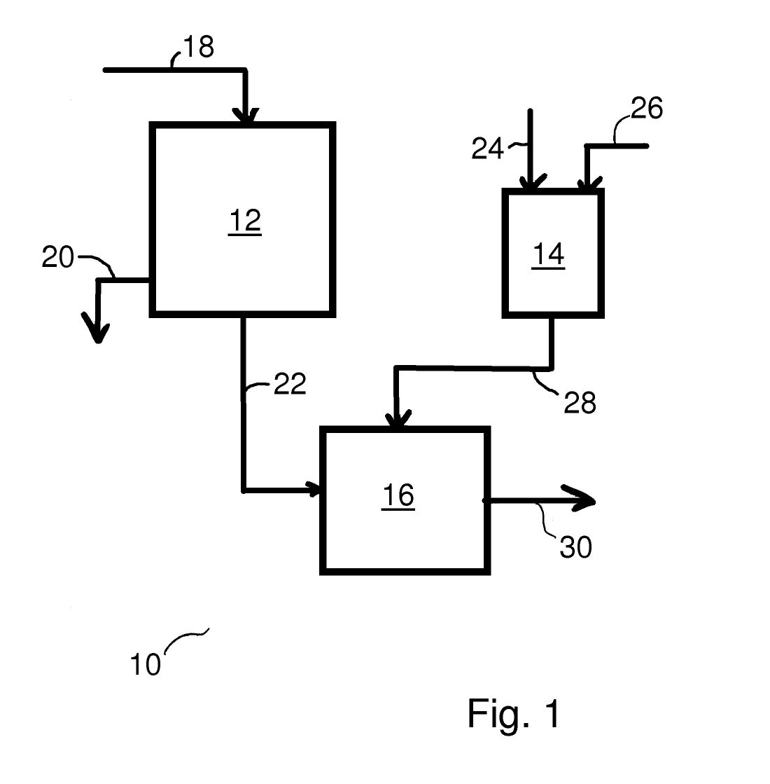

Referring to FIG. 1, a schematic representation of an essentially continuous, spreadable butter producing facility 10 is shown. A continuous butter churning device 12, such as a so-called “Fritz” device receives a feed of cream of 40-50% butterfat by continuous feeding through fee pipe 18. The Fritz device is operated in accordance with standard operating practises, and no modification of the churning process is contemplated. As such, it operates under normal conditions of pressure, temperature, pH, and the like.

The device includes a cooled horizontal cylindrical tank, where the cream is distributed in a film and beaten by blades revolving at 3000 revolutions per minute in order to cause separation of the butterfat from the buttermilk that will remain. The formed mass of churned butter falls into a trough, where buttermilk drains off through pipe 10, and the churned butter is removed through pipe 22.

Separately, canola oil is fed through pipe 24 to a mixer 14, wherein it is mixed with lecithin, fed through pipe 26, in the ratio of 98:2.

The resulting pre-mixed oil product is then fed through pipe 28 to a further mixer 16 where it is mixed with the butter received from churning device 12. The butter and pre-mixed oil product are mixed in a ratio such that the final composition has a composition of 51% butterfat, 48% canola oil, and 1% lecithin, when measured by weight, as solids. The mixture also includes an additional amount of water, which is primarily found in the butter portion. The resultant spreadable butter comprising 80% solids, and 20% water, is removed from mixer 16 through pipe 30.

After removal from mixer 16, the resultant spreadable butter is ready for further processing, including additional kneading (if necessary), packing and shipping or storage.

### Example

Using the method described in respect of FIG. 1, a spreadable butter was produced consisting of 51% butterfat (by weight of solids), 1% lecithin, and 48% canola oil, to form the 80% solids content of a spreadable butter (which also included 18% water, and 2% salt).

The resulting product was stored in a refrigerator at a temperature of 5° C. When removed from the refrigerator, the spreadable butter (at 5° C.) exhibited good spreadability similar to normal, 100% butter, at room temperature (e.g. 21° C.).

Additionally, when re-tested after storage at 5° C. for 1 week, the spreadability of the spreadable butter material of the present invention remained good. As such, a storable, spreadable butter has been provided.

Accordingly, it is apparent that there has been provided, in accordance with the present invention, a spreadable butter which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

It should be noted that unless otherwise specifically noted, all of the features described hereinabove may be combined with any of the above aspects, in any combination.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

1. A spreadable butter which is spreadable at refrigerator temperatures comprising a mixture of between 25 and 90% butterfat, based on weight of solids, between 10 and 75% percent of a vegetable oil, and between 0.2 and 5% of a phospholipid, with the resulting product including up to 25% by weight of water and other additives, wherein the butterfat is from churned butter, and essentially retains the crystalline structure of churned butter.

2. A spreadable butter as claimed in claim 1 wherein the level of butterfat is between 40 and 70%.

3. A spreadable butter as claimed in claim 1 wherein the level of vegetable oil is between 30 and 60%.

4. A spreadable butter as claimed in claim 1 wherein said vegetable oil is olive oil, corn oil, cottonseed oil, palm oil, peanut oil, rapeseed oil, canola oil, safflower oil, sesame oil, soybean oil, sunflower oil, nut or seed oils, almond oil, cashew oil, pine nut oil, hazelnut oil, oils from melon and gourd seeds, pumpkinseed oil, or watermelon seed oil, or combinations thereof.

5. A spreadable butter as claimed in claim 4 wherein said vegetable oil is canola oil.

6. A spreadable butter as claimed in claim 1 wherein said phospholipid is a glycerophospholipid.

7. A spreadable butter as claimed in claim 6 wherein said phospholipid is phosphatidyl inositol, cephalin, lecithin, phosphatidyl serine or cardiolipin.

8. A spreadable butter as claimed in claim 6 wherein said phospholipid is lecithin.

9. A spreadable butter as claimed in claim 6 wherein the level of phospholipid is between 0.4 and 2.5%, by weight of solids.

10. A spreadable butter as claimed in claim 1 wherein said refrigerator temperatures are between 3 and 12° C.

11. A spreadable butter as claimed in claim 1 wherein said phospholipid effects a reduction in surface tension over a system comprising only butterfat and vegetable oil.

12. A process for the production of a spreadable butter which is spreadable at refrigerator temperatures of about 4 to 8° C. comprising a mixture of between 25 and 90% butterfat, based on weight of solids, between 10 and 75% percent of a vegetable oil, and between 0.2 and 5% of a phospholipid, comprising: i) preparing a pre-mixed oil product by mixing a combination of between 0.2 and 5% by weight of solids of a phospholipid with between 10 and 75% of a vegetable oil, and ii) mixing said pre-mixed oil product with between 25 and 90% of already churned butter.

13. A process as claimed in claim 12, wherein said spreadable butter product has a butterfat content of at least 25%.

14. A process as claimed in claim 13, wherein said butterfat content is at least 50%.

15. A process as claimed in claim 12 wherein the level of phospholipid is between 0.5 and 1%, the level of vegetable oil is between 40 and 55%, and the level of butterfat is between 45 and 60%.

16. A process as claimed in claim 12 wherein said phospholipid is lecithin and said vegetable oil is canola oil.

17. A process as claimed in claim 12 wherein said pre-mixed oil product is a mixture of lecithin and canola oil, and which is a liquid material

18. A process as claimed in claim 17 wherein said pre-mixed oil product is added to said already churned butter at a temperature of between 10 and 20° C.

19. A process as claimed in claim 12 wherein said phospholipid effects a reduction in surface tension over a system comprising corresponding levels of vegetable oil and butter.
